(19) United States
(12) Patent Application Publication
(10) Pub. No.: US 2017/0158240 A1
(43) Pub. Date: Jun. 8, 2017

(54) METHOD FOR ASSISTING A DRIVER OF A MOTOR VEHICLE WHEN PARKING, DRIVER ASSISTANCE SYSTEM, AND MOTOR VEHICLE

(71) Applicant: VALEO Schalter und Sensoren GmbH, Bietigheim-Bissingen (DE)

(72) Inventors: Malte Joos, Bietigheim-Bissingen (DE); Martin Hoerer, Bietigheim-Bissingen (DE)

(73) Assignee: VALEO Schalter und Sensoren GmbH, Bietigheim-Bissingen (DE)

(21) Appl. No.: 15/321,233

(22) PCT Filed: May 22, 2015
(86) PCT No.: PCT/EP2015/061384

§ 371 Date: Dec. 22, 2016

(30) Foreign Application Priority Data
Jun. 26, 2014 (DE) 10 2014 108 949.9

(51) Int. Cl. B62D 15/02; B60W 50/14; B60W 40/02; G08G 1/16; B60W 30/06

(52) U.S. Cl. CPC B62D 15/0285; G08G 1/168; B62D 15/0275; B60W 30/06; B60W 40/02; B60W 50/14; B60W 2050/146

(57) ABSTRACT

The invention relates to a method for assisting a driver of a motor vehicle (1). The motor vehicle (1) is moved past a longitudinal parking space (5) up to an initial position (16) and sensor data, describing a spatial dimension of the longitudinal parking space (5), of at least one motor-vehicle-side sensor device (3) are made available during the movement of the motor vehicle (1) past the longitudinal parking space (5). Furthermore, a target line (8) is predetermined within the longitudinal parking space (5) on the basis of the sensor data, and a first driving trajectory (17) for a first parking movement of the motor vehicle (1) is determined starting from the initial position (16) in the direction of the target line (8) as a function of the sensor data. Furthermore, a second driving trajectory (12) is also determined for a second parking movement of the motor vehicle (1) following the first, as a function of the sensor data, wherein an intermediate position (13) on the second driving trajectory (12) is determined as a function of the sensor data. A third driving trajectory (14) for a third parking movement of the motor vehicle (1), following the second, is also determined starting from the intermediate position (13) to a target position (15) as a function of the sensor data, wherein the intermediate position (13) and the third driving trajectory (14) are determined in such a way that a longitudinal axis (11) of the motor vehicle (1) in the target position (15) is essentially congruent with the target line (8).

The invention relates to a method for assisting a driver of a motor vehicle when parking. In this context, the motor vehicle is moved past a longitudinal parking space up to an initial position and sensor data, describing a spatial dimension of the longitudinal parking space, are made available during the movement of the motor vehicle past the longitudinal parking space. In addition, a target line within the longitudinal parking space is predetermined on the basis of the sensor data, and a first driving trajectory for a first parking movement of the motor vehicle is determined starting from the initial position in the direction of the target line as a function of the sensor data. Furthermore, a second driving trajectory for a second parking movement of the motor vehicle following the first, is determined as a function of the sensor data. The invention also relates to a driver assistance system for a motor vehicle and to a motor vehicle having a driver assistance system.

Methods for assisting a driver of a motor vehicle when parking are already known from the prior art. At present, there is particular interest in methods in which the driver is assisted during reverse parking into a longitudinal parking space, that is to say a parking space for longitudinal parking. During the parking process, the motor vehicle is usually moved along at least one driving trajectory. In addition, methods are known in which the motor vehicle is moved into the parking space in a single parking movement. Furthermore, methods are known in which the motor vehicle is moved into the parking space in a plurality of parking movements. In this case, a first parking movement is carried out in a rearward direction. This first parking movement is then followed by a second parking movement in which the motor vehicle is moved forwards. The second parking movement is usually ended when the motor vehicle is located just before a collision with an object bounding the parking space, for example another motor vehicle.

In this context, DE 10 2009 025 328 A1 describes a method for carrying out an at least semi-autonomous parking process of a vehicle. Here, the position of a parking path point on the parking path, at which point the autonomous steering intervention has ended, is determined as a function of the parking path, The parking process is, however, carried out here in a single rearward movement, i.e. there is no change in the direction of travel between rearward travel to forward travel.

In known parking systems in which a plurality of parking movements and therefore a change of the travel direction are provided during the parking process, the forward movement has hitherto only been calculated in respect of a collision of the vehicle with the objects, e.g. parked vehicles, bounding the parking space. Such a method is described, for example, in DE 10 2004 047 483 A1. DE 10 2004 047 483 A1 discloses a parking method in which during forward driving and during reverse driving of the vehicle in the parking space the steering is set in each case in such a way that the vehicle reaches a predefined distance range and angle range with respect to the lateral parking space boundary. The change of travel direction becomes necessary owing to an excessively small distance from an obstacle before and/or behind the vehicle.

The object of the invention is to make available a method, a driver assistance system and a motor vehicle in which measures are taken which ensure that the parking of the motor vehicle can be carried out in a particularly precise and time-saving fashion.

This object is achieved according to the invention by means of a method, by means of a driver assistance system and by means of a motor vehicle having the features according to the respective independent patent claims. Advantageous embodiments of the invention are the subject matter of the dependent patent claims, of the description and of the figures.

In a method according to the invention, a driver of a motor vehicle is assisted when parking. The motor vehicle is moved past a longitudinal parking space up to an initial position, and sensor data, describing a spatial dimension of the longitudinal parking space, of at least one motor-vehicle-side sensor device are made available during the movement of the motor vehicle past the longitudinal parking space. Furthermore, a target line within the longitudinal parking space is predetermined on the basis of the sensor data, and a first driving trajectory for a first parking movement of the motor vehicle is determined starting from the initial position in the direction of the target line as a function of the sensor data. And a second driving trajectory is determined for a second parking movement of the motor vehicle following the first, as a function of the sensor data. According to the invention there is provision that an intermediate position is determined on the second driving trajectory as a function of the sensor data, and a third driving trajectory is determined for a third parking movement of the motor vehicle, following the second, starting from the intermediate position to a target position as a function of the sensor data, wherein the intermediate position and the third driving trajectory are determined hi such a way that a longitudinal axis of the motor vehicle in the target position is essentially congruent with the target line.

The method according to the invention makes it possible to determine, on the basis of the sensor data which is made available, the intermediate position in such a way that said position makes optimum execution of the third parking movement possible. Therefore, the possibility of carrying out the third parking movement is used as a preference for the determination of the intermediate point, said third parking movement providing that the longitudinal axis of the motor vehicle in the target position, that is to say that position in which the motor vehicle is ultimately stopped and parked, is essentially congruent with the target line. This means that the longitudinal axis of the motor vehicle should be located as close as possible to the target line. In contrast to methods from the prior art, the second parking movement is not necessarily carried out up to a position at which a collision with an obstacle or with an object bounding the longitudinal parking space is imminent. This also means that the travel direction is changed immediately after the second movement, at the location of the intermediate position, as soon as overlap between the longitudinal axis and the target axis can be essentially achieved by the third driving trajectory.

It is advantageous then that owing to the shortened second driving trajectory compared to methods from the prior art the motor vehicle is usually located in a steeper position in the longitudinal parking space with respect to the target line at the changeover between the second driving trajectory and the third driving trajectory. It follows from this in turn that the motor vehicle can be made to approach closer to the target line by means of the third parking movement compared to methods from the prior art. Therefore, a lateral distance from the longitudinal axis to the target line can be minimized. A further advantage is that time for the parking can be saved because the second driving trajectory is ended before the motor vehicle collides, just before the collision, with the object located in front of the motor vehicle in the forward travel direction.

In one embodiment there is provision that the target line is predetermined in such a way that it coincides with a longitudinal axis of the longitudinal parking space which extends along a main direction of extent of the longitudinal parking space and divides the longitudinal parking space centrally. The main direction of extent can therefore be arranged parallel to a road running next to the longitudinal parking space. The target line can therefore also run parallel to the road on which the longitudinal parking space is arranged. The advantage is that the target line is arranged inside the longitudinal parking space in such a way that after the motor vehicle has been ultimately parked essentially on the target line, said motor vehicle is arranged very precisely on the longitudinal parking space. This also has the advantage that the parked motor vehicle does not impede any other motor vehicles or other road users because said motor vehicle is not precisely parked in the parking space. The motor vehicle therefore does not project out on either of the two longitudinal sides of the longitudinal parking space.

In particular there is provision that the intermediate position and/or the third driving trajectory are determined in such a way that the longitudinal axis of the motor vehicle in the target position is aligned parallel to the target line. This therefore means that the intermediate position can be determined on the second driving trajectory in such a way that it is possible to connect the third driving trajectory from the intermediate position, and the third driving trajectory leads to the target position which has parallel orientation of the motor vehicle or of the longitudinal axis of the motor vehicle with respect to the target line. There can therefore be provision that the intermediate position is selected in such a way that the motor vehicle or the longitudinal axis of the motor vehicle is parked parallel to the target line. It is advantageous here that the intermediate position is determined as a function of the third driving trajectory—in contrast to the situation mentioned in the prior art—which determines the second driving trajectory as a function of an obstacle in front of the motor vehicle.

In this context, it proves particularly advantageous if the intermediate position and/or the third driving trajectory are determined in such a way that the longitudinal axis of the motor vehicle in the target position encloses with the target line an angle which is smaller than a predetermined limiting value. The angle can be predetermined in this case, since an ideal situation which gives rise to an angle of 0° cannot always be implemented. The predetermined limiting value can then be, for example, less than 5°, in particular less than 2° and preferably 1°. The predetermined limiting value can, however, also be less than 1° if particularly precise parking is desired and a longitudinal parking space which is correspondingly suitable for this purpose is available. It is therefore advantageous that by means of the limiting value for the angle it is possible to enter into situations which occur more frequently in reality and which differ from the ideal situation.

The intermediate position is preferably determined in such a way that it describes a point on the second driving trajectory, starting from which the motor vehicle, during movement of the motor vehicle on the second driving trajectory, reaches the target position for the first time through movement of the motor vehicle along the third driving trajectory. This means that the intermediate position is determined in such a way that the target position can be reached starting from the second driving trajectory by moving the motor vehicle along the third driving trajectory. It is advantageous here that the second driving trajectory is not driven on for longer than necessary. It is therefore possible, on the one hand, to save time for the parking process and, on the other hand, the motor vehicle can be parked more precisely in the longitudinal parking space. The earlier the intermediate position on the second trajectory is determined, that is to say the closer the intermediate position is to the target line, the steeper or further in the transverse direction of the longitudinal parking space the motor vehicle is located at the start of the third parking movement, and the closer the longitudinal axis of the motor vehicle can be moved to the target line. A lateral distance from the target line to the longitudinal axis of the motor vehicle can therefore be minimized.

In a further embodiment there is provision that the motor vehicle is moved rearwards during the first parking movement, forwards during the second parking movement and rearwards during the third parking movement. Therefore, the driver can be assisted during the reverse parking. The driver can therefore easily park the motor vehicle in parking spaces, in which only reverse parking is possible owing to the dimensions of said parking spaces.

Furthermore, there can be provision that after the third parking movement at least one further parking movement is executed as a function of the sensor data. This means that if the situation or the present longitudinal parking space requires it, at least one further parking movement can be adjoined after the third parking movement. However, a plurality of parking movements can also follow the third parking movement. This is dependent on the dimensions of the longitudinal parking space. It is advantageous here that if the dimensions of the longitudinal parking space require it manoeuvring can be carried out until the target position is reached.

In a further embodiment there is provision that the intermediate position is determined after the first parking movement. The intermediate position can therefore be determined as a function of the sensor data which is present after the first parking movement or after the travel along the first driving trajectory. This has the advantage that after the first parking movement the sensor data are present with a higher level of accuracy than was the case at the initial position. After the first parking movement, the sensor data and therefore the dimensions of the longitudinal parking space are therefore present in a more accurate form than before. The more accurate sensor data also give rise to more accurate determination of the intermediate position. Consequently, a more accurate intermediate position also provides the prospect of a more accurate target position.

In particular there is provision that the sensor data are updated continuously after being made available. This brings about a situation in which the sensor data can be made available more reliably. The reason for this is that the sensor device of the motor vehicle was then able to determine the sensor data at different positions of the motor vehicle. These different positions permit a view with a different orientation with respect to objects and obstacles which bound the longitudinal parking space. In this context, the motor vehicle can also be located closer to the objects or obstacles, as a result of which the sensor data can be made available with greater accuracy.

In a further embodiment, the parking is carried out semi-autonomously, in particular with an autonomous steering intervention, or autonomously. The advantage here is that a driver does not have to be concerned with the steering intervention but rather is responsible only for the acceleration and braking and possible operation of the clutch and gearshift. However, the parking can also be carried out autonomously, that is to say exclusively by means of the motor vehicle itself. Increased comfort for the driver and/or greater precision of the parking process are advantageous because human inaccuracy on the part of the driver can be ruled out.

A driver assistance system according to the invention for a motor vehicle having a sensor device for making available sensor data, and having an evaluation device which is configured to carry out a method according to one of the preceding claims.

In one refinement, the sensor device comprises an ultrasonic sensor and/or a camera and/or a radar sensor and/or a lidar sensor and/or a laser scanner, It is advantageous here that the can be selected for the corresponding situation or for the method for assisting the driver when parking. However, there can also be provision that various sensors of the sensor device are combined with one another in order to make available the sensor data. As a result of the redundancy of the sensors, a higher level of accuracy of the planned driving trajectories can be achieved and/or sensor data of another sensor can be used in the event of poor weather conditions. Therefore, for example, the radar sensor is particularly resistant to the weather compared to the other abovementioned sensors, Furthermore, the driver assistance system comprises a display device for displaying the initial position and/or the intermediate position and/or the target position. The respective position can therefore be displayed on the display device starting from the time when the sensor data are made available. The driver can therefore see, for example before the parking process has begun, where the target position and/or the intermediate position is located. An advantage is that the driver can also check the respective position as a result. Furthermore, these respective positions are helpful for semi-automatic parking. The driver is therefore informed, for example visually and/or acoustically and/or haptically, how and/or when he should react.

A motor vehicle according to the invention, in particular a passenger car, comprises a driver assistance system according to the invention.

The preferred embodiments which are presented with respect to the method according to the invention, and the advantages thereof, apply correspondingly to the driver assistance system according to the invention and to the motor vehicle according to the invention.

Further features of the invention can be found in the claims, the figures and the description of the figures. All the features and combinations of features mentioned above in the description and the features and combinations of features mentioned below in the description of the figures and/or merely illustrated in the figures can be used not only in the respectively specified combination but also in other combinations or else alone.

Exemplary embodiments of the invention are explained in more detail below with reference to schematic drawings, in which:

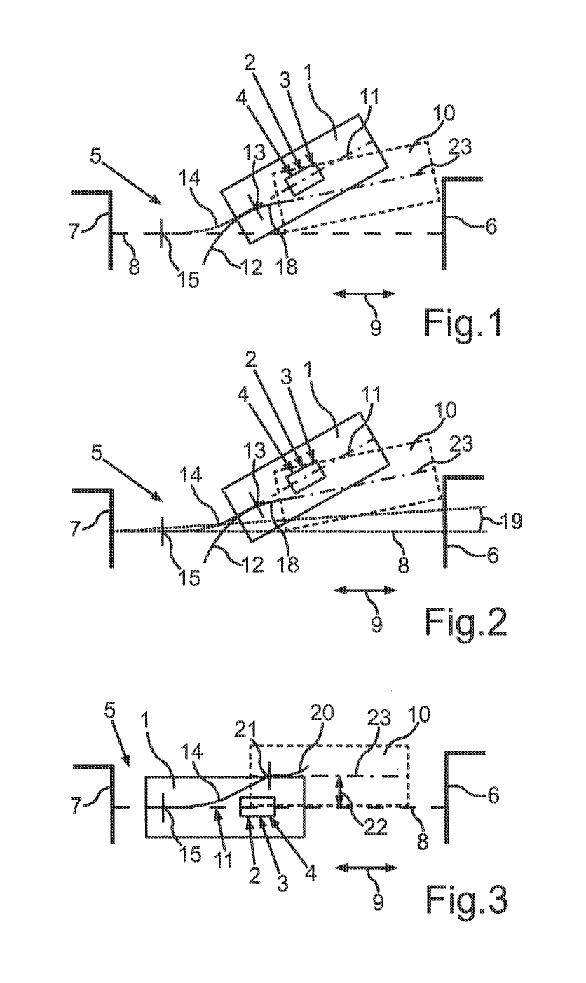

FIG. 1 shows a schematic plan view of an exemplary embodiment of a motor vehicle according to the invention during the execution of a parking process;

FIG. 2 shows a schematic plan view of an exemplary embodiment of the motor vehicle according to the invention during the execution of the parking process, wherein a longitudinal axis of the motor vehicle and a target line enclose an angle;

FIG. 3 shows a schematic plan view of an exemplary embodiment of the motor vehicle according to the invention during the execution of the parking process, wherein the longitudinal axis and the target line are essentially congruent; and

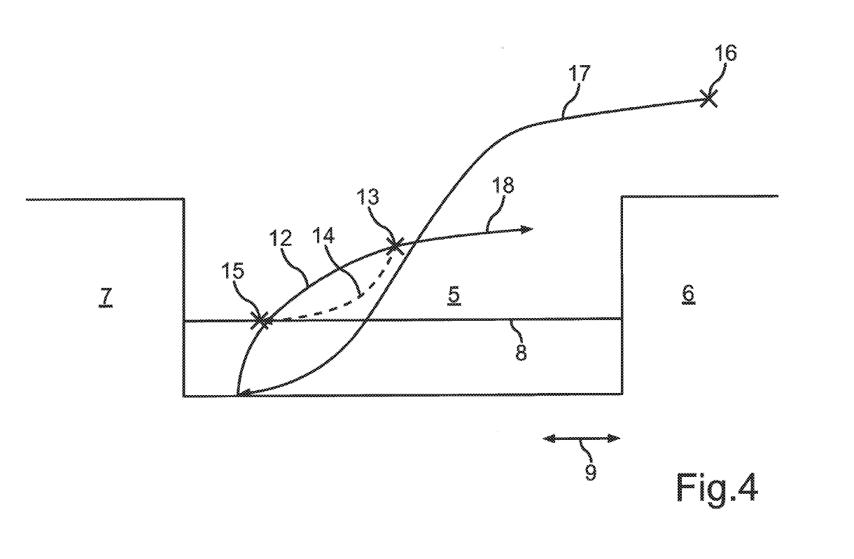

FIG. 4 shows a schematic illustration of a first parking movement along a first driving trajectory, a second parking movement along a second driving trajectory, and a third parking movement along a third driving trajectory, wherein the third driving trajectory starts from an intermediate position of the second driving trajectory.

FIGS. 1 to 3 respectively show a motor vehicle 1 schematically in a plan view. FIGS. 1 to 3 show the motor vehicle 1 during parking in a longitudinal parking space 5, The longitudinal parking space 5 is, in the present exemplary embodiment, a free parking area or a parking space into which the motor vehicle 1 can be moved by longitudinal parking. Furthermore, FIGS. 1 to 3 illustrate schematically a further motor vehicle 10 by means of dashed lines, which motor vehicle 10 is parked in the longitudinal parking space 5 according to a method in accordance with the prior art.

The motor vehicle 1 has a driver assistance system 2 according to an embodiment of the invention. The driver assistance system 2 comprises a sensor device 3 and an evaluation device 4, The arrangement of the driver assistance system 2 in and/or on the motor vehicle 1 is basically random. The arrangement of the driver assistance system 2 is preferably provided on the motor vehicle 1 in such a way that sensor data which describe a spatial dimension of a longitudinal parking space 5 can be made available in a particularly precise fashion. The longitudinal parking space 5 is bounded by a front object 6 and a rear object 7. Furthermore, the longitudinal parking space 5 has a target line 8 which extends along a main direction of extent 9 of the longitudinal parking space 5 and divides the longitudinal parking space 5 centrally. The main direction of extent 9 extends in the longitudinal direction of the longitudinal parking space, which therefore runs through the front object 6 and the rear object 7.

Furthermore there is provision that the sensor device 3 comprises an ultrasonic sensor and/or a camera and/or a radar sensor and/or a lidar sensor and/or a laser scanner. Every sensor has its own advantages which are selected in a situation-related fashion. However, the method according to the invention can basically be carried out with all sensors which can provide information about the dimension of the longitudinal parking space 5. The arrangement of the ultrasonic sensor and/or the camera and/or the radar sensor and/or the lidar sensor and/or the laser scanner on the motor vehicle 1 is random. Likewise, the number of respective sensors is random. The motor vehicle 1, 10 has a longitudinal axis 11 which divides the motor vehicle 1, 10 centrally and runs from the rear of the motor vehicle 1, 10 to the front of the motor vehicle 1, 10.

The longitudinal parking space 5 is dimensioned here in such a way that the motor vehicle 1 can be parked in a plurality of movements or parking movements. In particular, at least three parking movements are provided here, During the parking process, the motor vehicle 1 is moved rearwards along a first driving trajectory 17 during the first parking movement. In a second parking movement, the motor vehicle 1 is moved forwards along a second driving trajectory 12 which adjoins the first driving trajectory 17. In a third parking movement, the motor vehicle 1 is moved forwards again along a third driving trajectory 14 which adjoins the second driving trajectory 12,

FIG. 1 then shows the motor vehicle 1 at the end of the second parking movement during the movement along the second driving trajectory 12 at an intermediate position 13. The intermediate position 13 therefore constitutes here the end of the second driving trajectory 12. The intermediate position 13 relates in the present exemplary embodiment to the centre of the rear axis of the motor vehicle 1. However, any other location on the motor vehicle 1 can also serve as a reference point for the intermediate position 13. The intermediate position 13 on the second driving trajectory 12 is determined in such a way that starting from the intermediate position 13 the third driving trajectory 14 is possible from a third parking movement in the opposite travel direction to the second parking movement. Furthermore, the third driving trajectory 14 is selected or determined in such a way that a target position 15 can be reached when driving along the third driving trajectory 14, The target position 15 provides that the longitudinal axis 11 is essentially congruent with the target line 8.

The method according to the invention can then proceed as follows. The motor vehicle 1 drives past the longitudinal parking space 5, in order to make available the spatial dimension of the longitudinal parking space 5 by means of the sensor device 3. After the detection of the sensor data, the motor vehicle 1 is positioned at an initial position 16. Starting from the initial position 16, the first parking movement follows along the first driving trajectory 17. Here, the motor vehicle 1 is moved rearwards. At the end of the first driving trajectory 17, the motor vehicle 1 follows a change in direction. The motor vehicle 1 is then moved forwards along the second driving trajectory 12, but only until the motor vehicle 1 reaches the intermediate position 13. The intermediate position 13 is the earliest position on the second driving trajectory 12 from which the target position can be reached along the third driving trajectory 14.

The third driving trajectory 14 is therefore determined in such a way that with the third parking movement it is possible to provide a situation in which the target line 8 and the longitudinal axis 11 are essentially parallel and at the same time at a minimum distance from one another. The earlier the intermediate point 13 on the second driving trajectory 12 can be determined, or in other words the closer the intermediate point 13 is to the target line 8, the smaller the distance from the target line 8 to the longitudinal axis 11 can be in the target position 15. The reason for this is that the closer the intermediate point 13 is to the target line 8, the more oblique the positioning of the motor vehicle 1 in the longitudinal parking space 5 is, that is to say an angle between the target line 8 and the extended longitudinal axis 11 is greater than in the case of parking methods which are known from the prior art.

The motor vehicle 10 from the prior art also moves along the first driving trajectory 17 and also along the second driving trajectory 12. However, the motor vehicle 10 moves on an extended second driving trajectory 18 and does not stop at the intermediate position 13. The extended second driving trajectory 18 is therefore a continuation of the second driving trajectory 12. The motor vehicle 10 from the prior art therefore drives further along the extended second driving trajectory 18 until an imminent collision with the object 5 in front is indicated to the driver assistance system. Only then does the motor vehicle 10 from the prior art start a third parking movement along the third driving trajectory 14.

FIG. 2 shows a situation according to FIG. 1, wherein the intermediate position 13 is determined in such a way that in the target position 15 the longitudinal axis 11 encloses with the target line 8 an angle 19 which is smaller than a predetermined limiting value. The predetermined limiting value can be, for example, 1°, but it can also be smaller if the situation or the dimensions of the longitudinal parking space 5 and accuracy requirements of the parking process permit this. Conversely, the predetermined limiting value can also be larger if the situation or the dimensions of the longitudinal parking space 5 require it. The predetermined limiting value and the angle 19 can make it possible to depart from the strict condition of congruency between the target line 8 and the longitudinal axis 11. It is therefore possible, for example, for the target position 15 also to be already reached after the third parking movement in particular situations.

Additionally or alternatively, it may, however, also be provided that the third parking movement is also followed by at least one further parking movement. This may be necessary owing to particular dimensions of the longitudinal parking space 5 and/or particularly precise accuracy requirements of the parking process,

FIG. 3 shows the motor vehicle 1 in the target position 15 after the third parking movement has ended or the third driving trajectory 14 has been travelled along. Furthermore, FIG. 3 shows the motor vehicle 10 from the prior art, which motor vehicle 10 had to drive along a disadvantageous third driving trajectory 20 after the extended second driving trajectory 18, and is then stationary in a disadvantageous target position 21. According to the disadvantageous third driving trajectory 20 is the motor vehicle 10 from the prior art now with its longitudinal axis 11 further away from the target line 8 than the motor vehicle 1. A lateral difference from the disadvantageous target position 21 is now greater than a lateral difference from the target position 15 with respect to the target line 8.

FIG. 4 therefore shows once more in an illustration the first driving trajectory 17 starting from the initial position 16, the second driving trajectory 12 with the intermediate position 13, and the third driving trajectory 14 starting from the intermediate position 13. Finally, the longitudinal axis 11 (not illustrated here) comes to rest on the target line 8.

There is also provision that the driving trajectory 12, 14, 17 and/or the initial position 16 and/or the intermediate position 13 and/or the target position 15 are displayed on a display device. The indication can also be provided acoustically and/or haptically.

The motor vehicle 1 can also be moved semi-autonomously along the driving trajectories 12, 14, 17. A semi-autonomous movement can be, for example, an automatic steering intervention, wherein a driver of the motor vehicle 1 remains responsible for the acceleration or the deceleration. The motor vehicle 1 can also be moved autonomously along the driving trajectories 12, 14, 17.

1. A method for assisting a driver of a motor vehicle when parking, comprising:
moving the motor vehicle past a longitudinal parking space up to an initial position;
making available sensor data, describing a spatial dimension of the longitudinal parking space, of at least one motor-vehicle-side sensor device during the movement of the motor vehicle past the longitudinal parking space;
predetermining a target line within the longitudinal parking space on the basis of the sensor data;
determining a first driving trajectory for a first parking movement of the motor vehicle starting from the initial position in the direction of the target line as a function of the sensor data;
determining a second driving trajectory for a second parking movement of the motor vehicle following the first driving trajectory, as a function of the sensor data;
determining an intermediate position on the second driving trajectory as a function of the sensor data; and
determining a third driving trajectory for a third parking movement of the motor vehicle, following the second driving trajectory, starting from the intermediate position to a target position as a function of the sensor data,
wherein the intermediate position and the third driving trajectory are determined in such a way that a longitudinal axis of the motor vehicle in the target position is substantially congruent with the target line.

2. The method according to claim 1, wherein the target line is predetermined so that the target line coincides with a longitudinal axis of the longitudinal parking space which extends along a main direction of extent of the longitudinal parking space and divides the longitudinal parking space centrally.

3. The method according to claim 1, wherein the intermediate position and/or the third driving trajectory are determined so that the longitudinal axis of the motor vehicle in the target position is aligned parallel to the target line.

4. The method according to claim 1, wherein the intermediate position and/or the third driving trajectory are determined so that the longitudinal axis of the motor vehicle in the target position encloses with the target line an angle which is smaller than a predetermined limiting value.

5. The method according to claim 1, wherein the intermediate position is determined so that the intermediate position describes a point on the second driving trajectory, starting from which the motor vehicle, during movement of the motor vehicle on the second driving trajectory, reaches the target position for the first time through movement of the motor vehicle along the third driving trajectory.

6. The method according to claim 1, wherein the motor vehicle is moved rearwards during the first parking movement, forwards during the second parking movement and rearwards during the third parking movement.

7. The method according to claim 1, wherein after the third parking movement at least one further parking movement is executed as a function of the sensor data.

8. The method according to claim 1, wherein the intermediate position is determined after the first parking movement.

9. The method according to claim 1, wherein the sensor data are updated continuously after being made available.

10. The method according to claim 1, wherein the parking is carried out semi-autonomously with an autonomous steering intervention, or autonomously.

11. A driver assistance system for a motor vehicle having a sensor device for making available sensor data, and having an evaluation device which is configured to carry out a method according to claim 1.

12. The driver assistance system according to claim 11, wherein the sensor device comprises an ultrasonic sensor and/or a camera and/or a radar sensor and/or a lidar sensor and/or a laser scanner.

13. The driver assistance system according to claim 11, wherein the driver assistance system comprises a display device for displaying the initial position and/or the intermediate position and/or the target position.

14. A motor vehicle having a driver assistance system according to claim 11.
